(19) United States
(12) Patent Application Publication
(10) Pub. No.: US 2003/0235657 A1
(43) Pub. Date: Dec. 25, 2003

(54) Liquid film coating process

(76) Inventors: Peter Schweizer, Wunnewil (CH); Ferdinand Krebs, Wabern (CH)

Correspondence Address: McGLEW AND TUTTLE, P.C., SCARBOROUGH STATION, SCARBOROUGH, NY, 10510-0827, US

(21) Appl. No.: 10/465,907

(22) Filed: Jun. 19, 2003

(30) Foreign Application Priority Data
Jun. 21, 2002 (DE) P 102 27 789.3

(51) Int. Cl. B05D 1/30

(52) U.S. Cl. 427/420

(57) ABSTRACT

A liquid film coating process is provided in which a curtain (5) from at least one coating fluid (1) is poured on an object (10) being conveyed at right angles to the curtain (5). A fluid coating (6) is formed on the object (10) as a result. A mixture of a coating material and an organic carrier liquid, which has a surface tension of at most 40 mN/m, is used as the coating fluid (1). The fluid coating (6) is solidified to form the final coating. To solidify the fluid coating either the organic liquid is removed from the fluid coating formed from the mixture on the object by evaporation or a liquid that can be polymerized by heating is used as the organic liquid in order to solidify the fluid coating formed on the object by polymerizing the organic liquid.

### FIELD OF THE INVENTION

The present invention pertains to a liquid film coating process for the single-layer or multilayer coating of an object, especially a web-like substrate, e.g., a paper or cardboard material, a plastic film, a metal foil or strip or of web-like composites. However, the object to be coated may also be an individual product.

### BACKGROUND OF THE INVENTION

The liquid film coating process, also called curtain coating process, has been known for nearly 100 years. In its infancy, it was used for the single-layer coating of individual products, e.g., filled chocolate or furniture parts, as is described in DE 145 517 A. Since about 1960, the process has also been used for coating endless strips, e.g., cardboard materials and aluminum foils, and is described, e.g., by C. C. Poirier in “Curtain Coating of Corrugated Paper Board,” TAPPI, 49 (10): 66A-67A. The first, technically highly developed curtain process for applying one layer or simultaneously a plurality of layers on an endless substrate, especially photographic films, is described in U.S. Pat. No. 3,508,947. One example of the coating for producing magnetic recording materials is known from U.S. Pat. No. 5,044,305, and the coating for producing a thermal recording material or an ink jet recording material is described in DE 100 33 056 A1.

The common feature of most processes is that water-based carrier liquids are used for the particular coating material for the coating fluid or for the plurality of coating fluids. To set the surface tension of the carrier liquid and, as a result, ultimately the surface tension of the particular coating fluid as desired, wetting agents are added to the coating fluids, i.e., the aqueous carrier liquids. The wetting agents shall lower the surface tension of the carrier liquid. DE 100 33 056 A1 proposes, e.g., that the surface tension of a carrier liquid of a coating fluid, which forms the lowermost layer of the coating on the object to be coated, shall be 18 to 45 mN/m. DE 100 33 056 A1 also teaches that a surface tension gradient should prevail within the plurality of layers of the coating fluids and that a coating fluid that forms a top layer of the coating on the object should have a lower surface tension than the coating fluid that forms a lower layer of the coating on the object.

However, experience has shown that the prior-art coating processes are problematic in terms of the stability of the curtain, especially in the case of a multilayer curtain, but even in the case of a single-layer curtain. The problems intensify with decreasing layer thickness and with decreasing velocity of conveying of the object being coated and especially in case of the coincidence of a small layer thickness and a low velocity of conveying. The curtain built up layer by layer from the coating fluid or the plurality of coating fluids tends to tear under the production conditions.

### SUMMARY OF THE INVENTION

The object of the present invention is therefore to improve the stability of the curtain of a liquid film coating process.

The present invention pertains to a multilayer liquid film coating process, in which a curtain of at least one coating fluid is poured on an object being conveyed at right angles to the curtain and a fluid coating is formed on the object as a result. The direction of conveying of the object being coated may be normal to the curtain or it may also have a slope deviating from the normal direction. The fluid coating formed on the object is subsequently solidified.

According to the present invention, the coating fluid is based on an organic liquid or on a plurality of organic liquids. The organic liquid or the plurality of organic liquids may be able to be solidified by a chemical reaction and form a coating material or a part of a coating material itself/themselves, or they may be a volatile carrier liquid or a plurality of volatile carrier liquids, which is/are not part of the coating material itself/themselves. The material that forms a coating or a single layer of a coating after the solidification is called coating material according to the present invention. The coating material may consist of, e.g., binders, pigments and additives or may be another material assuming a desired function. In many cases, the coating fluid is therefore a mixture of different substances, and at least one of these substances is an organic liquid according to the present invention. This organic liquid may in turn form the coating material or part of the coating material or a carrier liquid for a coating material. The mixture may be a liquid or a dispersion, e.g., a suspension or emulsion.

The organic carrier liquid of a coating fluid formed as a mixture and, if the coating material is formed by an organic liquid, this organic liquid, have a surface tension of at most 40 mN/m, i.e., at most 40·10⁻³ N/m. Organic liquids and organic carrier liquids that can be solidified by chemical reaction will hereinafter be called organic liquids. The term “organic carrier liquid” is used only if the organic liquid in question is removed from the coating fluid, e.g., by evaporation, after the coating.

In particular, the use of wetting agents, which are used to lower the surface tension in the case of the use of water or aqueous solutions as the carrier liquid, is eliminated by the use of an organic liquid. Consequently, the organic liquid is free from wetting agent in an especially preferred embodiment of the present invention.

Organic liquids, e.g., ketones, alcohols, esters, aliphatic and aromatic hydrocarbons and ethers, inherently possess the surface tension required according to the present invention, so that excellent uniformity of the layers in the film and on the object will become established in the case of the use of a plurality of coating fluids. The uniformity also becomes established in a satisfactory manner, in particular, at small layer thicknesses at low web velocities. Compared with aqueous carrier liquids, this means a decisive widening of the operating window for the curtain coating process.

The organic carrier liquid may be a carrier liquid evaporating on heating, so that a single-layer coating or the layer of a multilayer coating that is formed from the coating fluid is solidified by heating, namely, by removing the carrier.

As an alternative, the coating fluid may also be an organic liquid that can be solidified by introducing energy and forms the coating material directly, without volatile components, or it may contain such an organic liquid, especially a monomer or oligomer, i.e., a reactive organic liquid. In this embodiment of the present invention, the organic liquid may be a liquid that can be polymerized by heating in order to solidify the coating or only the layer(s) in question by heating and polymerizing the organic liquid. The organic liquid may advantageously also be a liquid polymerizable by UV radiation or electron beams, so that a single-layer coating or the layer of a multilayer coating formed from the coating fluid can be polymerized by a corresponding radiation and solidified as a result.

The present invention is especially suitable for forming multilayer coatings. All coatings or some of the plurality of coatings may be formed by another coating fluid each. It is also possible to form two or more of the layers from the same coating fluid. However, each of the organic liquids that form or jointly form the coating fluids is especially preferably an organic liquid that has a surface tension of at most 40 mN/m. In other words, each of the coating fluids is formed according to the present invention. The plurality of coating fluids are preferably built up with organic carrier liquid only or they contain it or they are only organic liquids that are solidified by polymerization. However, the two types of coating fluids may, in principle, also form different layers in the same curtain.

The coating fluids forming the curtain are formed not only with different coating materials, but also with different organic liquids. However, the different organic liquids should have at least approximately equal surface tensions in this case. If the organic carrier liquids of the mixtures or the organic liquids forming directly the coating material or part thereof have different surface tensions, the differences should not be greater than 5 mN/m and preferably not greater than 2 mN/m. It is especially preferable for all organic liquids to have equal surface tension. The requirement for equal surface tension or at least approximately equal surface tension can be met most simply in mixtures by using the same organic liquid.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1 is a schematic view of the coating of a web material according to a multilayer curtain process according to the invention;

FIG. 2 is a diagram showing the dynamic surface tension of an aqueous carrier as a function of the surface age of the coating fluid;

FIG. 3 is a diagram showing the fall time of the curtain as a function of the height of the curtain; and

FIG. 4 is a diagram showing the surface tension in single-layer or multilayer liquid films and curtains of aqueous solutions with wetting agents using a cascade nozzle.

### DESCRIPTION OF THE PREFERRED EMBODIMENTS

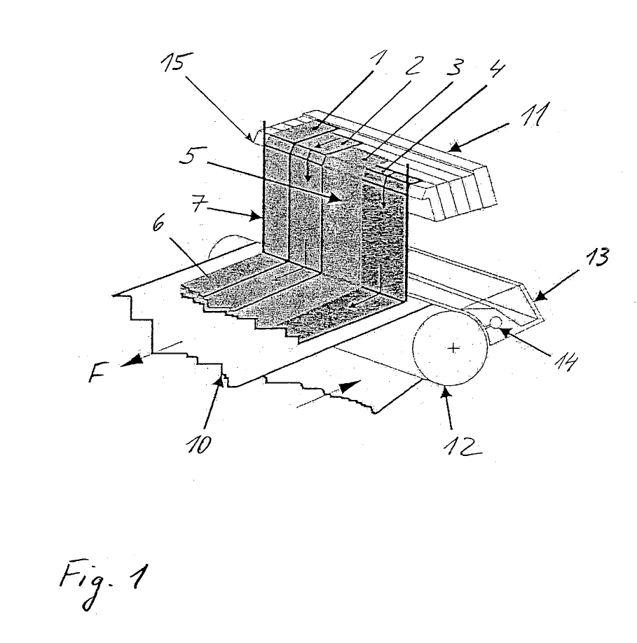

Referring to the drawings in particular, FIG. 1 shows a coating device for liquid coating by means of a multilayer curtain of coating fluids.

The coating device comprises a nozzle means 11 for generating the curtain from the plurality of coating fluids, in the exemplary embodiment from the four different coating fluids 1 through 4. However, the following explanations also apply to fewer than four coating fluids, e.g., also to a curtain from a single coating fluid. These explanations also apply to curtains with more than four different coating fluids. Such a curtain may be formed with ten or even more layers. The number of the different coating fluids in the curtain may be just as high as well.

However, the nozzle means 11 for a multilayer cascade nozzle could also be formed, e.g., from a slot nozzle with multiple slots. The coating fluids 1 through 4 are fed to the nozzle means 11 separately and metered at a feed rate corresponding to the particular consumption. Such nozzle means are known and therefore do not need to be described in greater detail.

A material web 10, with its surface to be coated facing the nozzle means 11, is conveyed endlessly under the nozzle means 11 by a conveying means in a direction of conveying F. The material web 10 may be, e.g., a paper web, a plastic film or a metal foil.

The nozzle means 11 forms slots, which extend in parallel at right angles to the material web 10, are arranged one after another in the direction of conveying F and through which the coating fluids 1 through 4 can be discharged and flow after their discharge on a top side of the nozzle means 11 facing away from the material web 10 in the direction of conveying F. Due to the slots being arranged one after another in the direction of conveying F, a multilayer liquid film is generated on the top side of the nozzle means 11. The liquid film on the top side of the nozzle means 11 already has the layer structure of the later coating of the material web 10. This multilayer liquid film flows on the top side of the nozzle means 11 in the direction of conveying F of the material web 10 up to a front nozzle lip 15 of the nozzle means 11. After separation from the nozzle lip 15, the multilayer liquid film falls by free fall essentially vertically onto the material web 10 being conveyed under the nozzle lip 15, forming a curtain 5, it reaches the top side of the material web 10 and forms a multilayer fluid coating 6. The width of the curtain 5 measured at right angles to the direction of conveying F is predetermined by a bilateral side edge 7.

The fluid coating 6 formed on the material web 10 is subsequently solidified, e.g., by drying.

The coating device comprises, furthermore, a pouring roller 12, which is arranged under the nozzle means 11 and around which the material web 10 is deflected. The curtain 5 reaches the top side of the material web 10 in an area of the web that runs off from the pouring roller 12 but is still supported by the pouring roller 12. Furthermore, a collecting tray 13 with integrated suction device 14 is arranged on the outside of the pouring roller 12 upstream of the line at which the curtain 5 reaches the material 10. The collecting tray 13 is used during fill up and cleaning of the nozzle means 11 as well as to initially form the liquid curtain. The nozzle means 11 is pushed back horizontally into a parking position during these phases of the operation such that the coating fluids separating from the nozzle lip 15 fall directly into the tray 13 located directly under it.

The wall of the tray 13 that is located opposite the pouring roller 12 is, moreover, designed such that a narrow, precise and concentric gap is formed between the tray 13 and the pouring roller 12 or the material web 10 wrapped around the pouring roller 12. The width of this gap must be small, preferably 0.5 mm, so that the tray 13 with its underside will exert a doctor effect, with which an essential part of the boundary air layer being entrained by the uncoated material web 10 is removed, i.e., it is removed by the doctor effect. Moreover, part of the boundary layer air, which enters the concentric gap between the tray 13 and the pouring roller 12, is drawn off by means of an external vacuum source with the suction device 14 comprising a relatively narrow slot and a relatively large channel (vacuum cleaner principle). The removal by doctor effect and drawing off of an essential part of the boundary layer air is such that the curtain process can also be operated at high velocities of the material web 10 without the residual amount of boundary layer air being drawn in between the curtain 5 and the material web 10 along the wetting line of the impacting curtain 5, which wetting line extends at right angles to the material web 10.

Each of the coating fluids 1 through 4 is or contains an organic liquid, which forms as such at the same time the coating material or part thereof, or a mixture of a coating material and an organic carrier liquid, which can also be called a solvent in the case of a solution of the coating material in the carrier liquid. All coating fluids 1 through 4, if they are mixtures, may be dispersions, e.g., emulsions or suspensions, or solutions. All mixed forms in which one or more of the coating fluids 1 through 4 is/are a solution and another of the coating fluids 1 through 4 or a plurality of the other coating fluids 1 through 4 is/are a dispersion, are possible. One or more of the layers may also be a mixture and another of the layers or a plurality of the other layers may be an organic liquid forming the coating material or part thereof. However, it is essential for all liquids or for their majority to be of an organic nature in order to guarantee the stability of the curtain 5. Even though it shall be categorically ruled out that one or another of the liquids is based on water, it is far more preferred for the liquids of the coating fluids 1 through 4 forming the curtain 5 to be of an organic nature without exception.

As was mentioned, the stability of the curtain is an important aspect of the curtain coating process. A liquid curtain, e.g., the curtain 5, is characterized as stable if it cannot be torn up by steadily present interfering effects over long operating times, i.e., over several hours. Such a curtain is also called suitable for production, i.e., it can be used for the industrial coating.

It was recognized in the present invention that a low surface tension of at most 40 mN/m of the liquids used is favorable for the stability of the curtain, especially if dynamic processes can be reduced or ideally completely avoided. Such dynamic processes are flow processes and diffusion processes within the fluid layers and between the fluid layers of the curtain. Such dynamic processes are reduced according to the present invention to the extent of becoming practically insignificant by the liquid being of an organic nature in the case of a single-layer curtain and by the majority of the liquids or especially preferably all liquids being of an organic nature in the case of a multilayer curtain. If the different coating materials of a multilayer coating makes it possible, only a single organic liquid should be used for mixtures with one other coating material each for such different coating fluids of the curtain in order to maintain the identity of the surface tension.

The problem of time-dependent flow and diffusion processes in liquid curtains is known, in principle, e.g., from “Surfactants: Static and Dynamic Surface Tension,” Y. M. Tricot, in: Liquid Film Coating, Chapter 4, Chapman & Hall, London. The surface tension of newly formed surfaces is a time-dependent and consequently dynamic property of the material in the case of aqueous solutions, because surface-active molecules contained in them first diffuse from the interior of the liquid to the surface and are adsorbed there before they lower the surface tension. The diffusion process above all is strongly affected by the viscosity of the liquid and the local flow conditions.

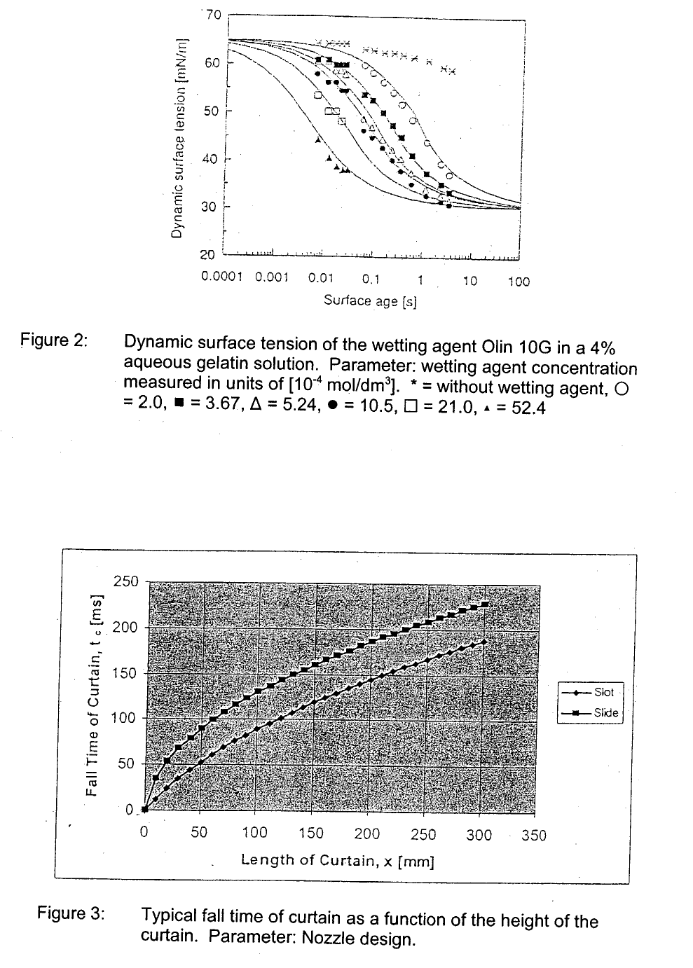

FIG. 2 shows the relationship, which depends on the age of the free liquid surface, the characteristic time of the diffusion process and the wetting agent concentration. It is known that the characteristic time of the diffusion process depends on the type of the wetting agent used, i.e., its molecular structure, and on the concentration of the wetting agent. The characteristic time may reach several seconds. In case of a sufficiently long diffusion time, the equilibrium surface tension, i.e., the static surface tension, is reached. Until the static surface tension is reached, aqueous solutions mixed with wetting agents therefore have a changing surface tension.

FIG. 2 shows, in particular, that a low surface tension of 40 mN/m and preferably lower can be reached if the surface age of the aqueous solution in question is low only if large amounts of a rapidly diffusing wetting agent are added. Even though the addition of wetting agents can optimize the stability of the curtain, it is problematic or even prohibited in many potential applications. Wetting agents are undesired in packaging materials for, e.g., foods or drugs or are not allowed by the approving authorities in charge, e.g., the FDA in the U.S.A. if the wetting agent molecules come into contact with the product to be packaged and there is a risk that the properties of the products could be altered by the wetting agent molecules passing over into the filling. Wetting agents may also be problematic in materials that shall be printed on after the coating, e.g., according to an ink jet process, because that may adversely affect the wetting and the flow of the ink on the material to be printed. The present invention offers remedies here, especially if the use of wetting agents is abandoned altogether, for which the present invention creates precisely the best prerequisites. Thus, the present invention opens up new fields of application, namely, especially those mentioned above, for the curtain coating processes which are especially suitable for mass production.

The characteristic diffusion time shall be compared below with the characteristic fall time of the curtain for the analysis of the stability of the curtain:

The fall time depends on the velocity V_{V} of the curtain, which is in turn determined approximately by the initial velocity V₀, which depends on the type of the nozzle, by the fall height x of the curtain and by the gravitational acceleration g according to the equation

V_{V}=V₀+\sqrt{2}gx (1)

The initial velocity V₀ may, in general, be ignored for practice, because its dependence on the type of the nozzle is usually weak and the initial velocity is usually substantially lower than the gravity term in Equation (1).

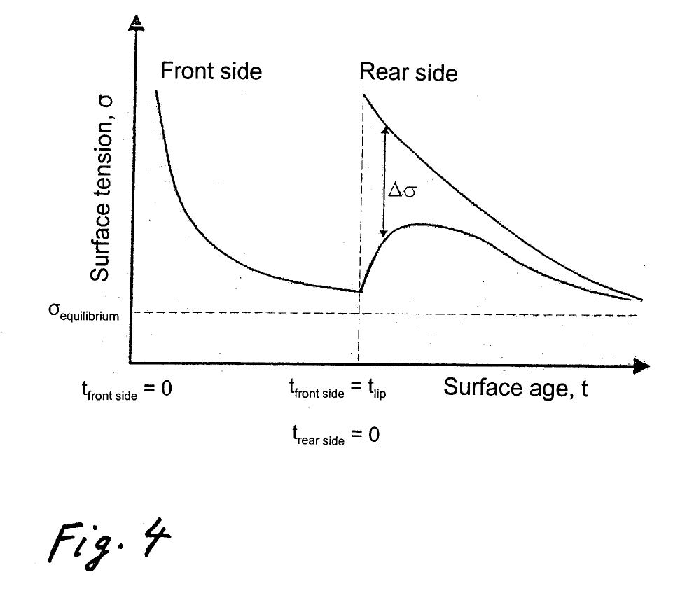

FIG. 3 shows a typical example of the dependence of the fall time of the curtain on the fall height x. The fall time of the curtain is consequently between 50 ms and 200 ms for industrially relevant curtain heights of 50 mm to 300 mm. This is a very short time, especially compared with the diffusion time that is necessary to generate the surface tension of at most 40 mN/m and preferably less that is significant because of the low surface age in the curtain. As is described in “Curtain Coating” by K. Miyamoto and Y. Katagiri, Chapter 11c in: Liquid Film Coating, Chapman & Hall, London, the theoretical stability criterion for the curtain can be quantified according to Equation (2) below:

$$We = \frac{ρ {QV}_{V}}{σ} = \frac{ρ {UH}_{F} {V}_{V}}{σ} > 2 \qquad ( 2 )$$

We is the dimensionless Weber number, which describes the ratio of the inertial forces to the surface tension forces, ρ and σ are the density and the surface tension of the coating fluid, Q is the ratio of the volume flow to the width, V_{V} is the velocity of the curtain according to Equation (1), U is the velocity of the web to be coated, and H_{F} is the wet thickness of the coating on the web.

The curtain coating process belongs to the class of the so-called premetered coating processes, in which precisely the amount of coating fluid exactly needed is pumped to the nozzle means. Contrary to other coating processes, such as rolling, doctor blade or air knife processes, the curtain process is carried out without excess liquid. It can therefore be inferred based on the law of mass conservation that the volume flow V* and consequently also the volume flow per width Q depend on the pouring width W, the web velocity U and the wet film thickness H_{F} according to Equation (3) below:

V*=QW=UH_{F}W (3)

In particular, the volume flow per width Q is determined by the web velocity U and the wet film thickness H_{F} as follows:

Q=UH_{F} (4)

What can be inferred from Equation (2) is not only that the stability of the curtain depends on the surface tension a and the volume flow/width Q, but also that the stability of the curtain also continues to be guaranteed at low values of Q as long as the surface tension σ is sufficiently low. Furthermore, it can be inferred from Equation (4) that the wet film thickness H_{F} at a given web velocity U or the web velocity U at a given film thickness H_{F} can be reduced all the more, the lower the surface tension σ. The preparation of very thin layers and also the coating at very low web velocities with the curtain process are of industrial significance because an extremely high degree of uniformity and consequently high quality of the coating can be achieved as a result.

It is mentioned in U.S. Pat. No. 3,632,374 that the minimal volume flow per width Q for aqueous solutions is about 0.5 cm²/sec. However, the stability of the curtain can hardly be maintained over long operating times with this minimum for Q. The minimum of Q for industrial applications should rather be at least 1.0 cm²/sec in case of the use of aqueous solutions as the carrier liquid. However, this high value makes it, on the other hand, impossible to produce thin layers and especially thin layers at simultaneously low web velocities, which is often a drawback in industrial applications of the curtain coating process.

Furthermore, it was recognized in the present invention that not only the lowermost layer of a multilayer curtain should have a low surface tension, as is required in DE 100 33 056 A1. The effect of a low surface tension becoming established rapidly on the stability of the curtain is based on the ability of avoiding local cross flows, so-called Marangoni flows, on the curtain surface, which are generated by local differences in the surface tension as a consequence of disturbances. On the one hand, a liquid curtain has two outer surfaces, on which disturbances can act. On the other hand, the layers between the outermost layer in a multilayer application also must have the capability of rapidly reducing their surface tension to these values in order for the stability of the curtain to continue to be guaranteed even when the outer layers are no longer able to withstand the disturbances. A multilayer curtain is consequently industrially robust or stable especially when all layers of the curtain have according to the present invention a low surface tension of at most 40 mN/m. The surface tensions of all layers are preferably even lower.

Further problems may arise when the curtain coating process is used for aqueous solutions combined with a cascade nozzle, as is shown, e.g., in FIG. 1. In particular, an asymmetric situation arises with this nozzle configuration in terms of the surface tension between the outer curtain surface that is the front surface in the direction of conveying F of the material web 10 and the rear outer curtain surface.

As is apparent from FIG. 1, the outer front curtain surface originates from the discharge of the topmost layer 1 from the slot on the oblique plane of the cascade nozzle 11. Depending on the number of the layers, this site may be far enough from the nozzle lip 15. If three fluid layers are formed, the distance between the outlet of the slot and the nozzle lip 15 is, e.g., approx. 150 mm. The age of the free film surface at the site of the nozzle lip 15, i.e., at the site at which the curtain 5 begins, is determined by the velocity of flow of the multilayer fluid film on the oblique plane. The velocity of flow depends on the viscosities of the coating fluids, their densities and volume flows and the slope angle. For a three-layer fluid film with a viscosity of 50 mpas, the surface age at the nozzle lip 15 is about 2 sec. Wetting agent molecules can diffuse during this time to the liquid surface when aqueous carrier liquids are used and reduce the surface tension as a consequence of adsorption.

As is schematically shown in FIG. 4, the front surface of the curtain therefore has a low surface tension at the beginning of the curtain, i.e., at the nozzle lip 15. If the flow time of the fluid film on the nozzle surface is long enough, the surface tension even reaches the equilibrium value, which corresponds to the static surface tension. The front outer surface of the curtain is stretched below the nozzle lip 15 as a consequence of gravitational acceleration, i.e., a new liquid surface is formed there, which contains fewer wetting agent molecules immediately after its formation, so that the local surface tension will again increase at first before it decreases again after a fall time of the curtain as a consequence of the diffusion and adsorption of the wetting agent. FIG. 4 shows this relationship and also the changes in the surface tension as a function of the surface age for the rear outer surface of the curtain.

The rear outer surface of the curtain (rear side) originates from the nozzle lip 15. Likewise as a consequence of the gravitational acceleration, this surface is stretched immediately after its formation, so that the surface tension decreases, as was described above, only relatively slowly. As a consequence of this, there is a difference Δσ in the surface tension between the front and rear outer surfaces of the curtain, which may be very great at the nozzle lip 15 and decreases with increasing fall time, i.e., as a function of the height of the curtain. However, this surface tension difference Δσ between the two outer surfaces of the curtain leads to an effect on the fall curve of the curtain. In particular, the curtain may be bent strongly backward directly below the nozzle lip 15. This phenomenon is known under the term “tea pot effect” and leads to a reduction in the stability of the curtain, because it becomes difficult to harmonize the fall curve of the curtain with the shape of the side edge 7 of the curtain. On the other hand, lines and streaks may develop in the curtain as a consequence of swirl formation along the rear edge of the nozzle lip 15, which adversely affects the quality of the coating on the material web 10.

The above-described drawbacks are avoided according to the present invention by the curtain coating process being carried out with liquids that are based on organic substances, i.e., with organic liquids. Many of these liquids have an inherently low surface tension of less than 40 mN/m. A large number of organic carrier liquids commonly used industrially for other applications, especially solvents, have a surface tension in the range of 15 to 35 mN/m, as is preferred for the purposes of the present invention. The problem of the dynamic surface tension is eliminated with organic liquids because the surface tension does not need to be lowered by dynamic effects such as diffusion and adsorption. The surface tension of such liquids is therefore also low if the surface age is very low, and it is lower than the maximum of 40 mN/m, which is not be exceeded according to the present invention. This was able to be demonstrated by the direct measurement of the surface tension in the curtain by means of the detection method as is described in the paper “Surfactants: Static and Dynamic Surface Tension,” which originates from Y. M. Tricot. Another advantage is that the surface tension does not need to be lowered by adding wetting agent molecules. The requirement of a low surface tension for all layers is inherently met in the case of multilayer applications.

Both low-boiling and high-boiling liquids are suitable for use as organic carrier liquids as long as the surface tension does not exceed the value of 40 mN/m. Suitable carrier liquids are, e.g., ketones, e.g., acetone, butanone and cyclohexanone, as well as alcohols, e.g., ethanol, butyl alcohol and cyclohexanol, and esters, e.g., ethyl acetate, but also butyl acetate, and, finally also aliphatic and aromatic hydrocarbons, e.g., special boiling-point spirit and toluene. Ethers, such as tetrahydrofuran or substances with other functional groups or substances with a plurality of functional groups, such as chlorobenzene or 2-methoxy-1-propyl acetate, may also be used. Mixtures of the aforementioned carrier liquids may also be used in the sense of the present invention and are subsumed under the term of the carrier liquid.

The advantages according to the present invention can be achieved not only with physicochemically drying systems containing volatile carrier liquids, but also with systems that contain reactive organic liquids including liquid mixtures that undergo polymerization under the effect of high-energy radiation, preferably UV radiation or electron beams or by the action of higher temperatures and bring about the solidification of the fluid coating on the material web as a result.

Time-dependent problems, such as changes in concentration, changes in viscosity, foaming and the like, which are typical in roller and doctor blade processes because the free liquid surface is smaller in the curtain coating process as a consequence of the closed metering system, are eliminated with the use of low-boiling, evaporating carrier liquids. The fire and explosion hazards and the occupational hygienic problems decrease correspondingly because of the markedly reduced losses due to evaporation.

While specific embodiments of the invention have been shown and described in detail to illustrate the application of the principles of the invention, it will be understood that the invention may be embodied otherwise without departing from such principles.

What is claimed is:

1. A liquid film coating process, comprising:
a) forming a curtain of at least one coating fluid to pour the fluid on an object, the object being conveyed at right angles to the curtain; and
b) forming a fluid coating on the object as the fluid curtain is poured on the object being conveyed;
c) using an organic liquid as the coating fluid that can be solidified on the object or using a mixture of a coating material and an organic liquid as the coating fluid that can be solidified on the object;
d) wherein the organic liquid has a surface tension of at most 40 mN/M; and
e) solidifying the fluid coating.

2. A liquid film coating process in accordance with claim 1, wherein the organic liquid has a surface tension of at most 35 mN/m.

3. A liquid film coating process in accordance with claim 1, wherein the organic liquid is free from wetting agent.

4. A liquid film coating process in accordance with claim 1, wherein the organic liquid is removed from the fluid coating formed from the mixture on the object by evaporation in order to solidify the coating.

5. A liquid film coating process in accordance with claim 1, wherein a liquid that can be polymerized by heating is used as the organic liquid in order to solidify the fluid coating formed on the object by polymerizing the organic liquid.

6. A liquid film coating process in accordance with claim 1, wherein a liquid that can be polymerized by one of irradiation, UV irradiation, and electron beams, is used as the organic liquid in order to solidify the fluid coating formed on the object (10) by polymerizing the organic liquid.

7. A liquid film coating process in accordance with claim 1, wherein the curtain comprises a single layer of a coating fluid.

8. A liquid film coating process in accordance with claim 1, wherein the curtain comprises a plurality of layers of coating fluids or contains a plurality of layers of the coating fluids and each of the coating fluids of the plurality of layers is said coating fluid.

9. A liquid film coating process in accordance with claim 8, wherein each of the organic liquids that form or jointly form the coating fluids of the plurality of layers has a surface tension that differs from the surface tension of each of the other organic liquids by from one of at most 5 mN/m and at most 2 mN/m.

10. A liquid film coating process in accordance with claim 8, wherein the organic liquids of all said coating fluids of the plurality of layers have the same surface tension.

11. A liquid film coating process in accordance with claims 8 wherein at least one of the coating fluids of the plurality of layers is a mixture of a coating material and an organic liquid.

12. A liquid film coating process in accordance with claim 8, wherein a plurality of the coating fluids of the plurality of layers are a mixture each of a coating material and the same organic liquid, wherein the coating material of at least one of the mixtures is different from the coating material of at least one other of the mixtures.

13. A liquid film coating process in accordance with claim 8, wherein each of the coating fluids of the plurality of layers is a mixture of a coating material and the same organic liquid.

14. A liquid film coating process in accordance with claim 12, wherein the coating material of each of the mixtures is different from the coating material of each of the other mixtures.

15. A liquid film coating process in accordance with claim 8, wherein at least one of the coating fluids of the plurality of layers is an organic liquid that can be solidified by the introduction of energy or by polymerization.

16. A liquid film coating process in accordance with claim 8, wherein all said coating fluids of the plurality of layers are organic liquids that can be solidified by introducing energy or by polymerization, wherein at least two of the organic liquids that are adjacent to each other are different from each other.

17. A liquid film coating process comprising the steps of:
forming a curtain of at least one coating fluid;
disposing the curtain to pour the fluid on an object;
during the pouring moving the object under the curtain to form a fluid coating on the object as the fluid curtain is poured on the object being conveyed;
using an organic liquid as the coating fluid that can be solidified on the object or using a mixture of a coating material and an organic liquid to provide the coating fluid that can be solidified on the object wherein the organic liquid with a surface tension of at most 40 mN/M; and
solidifying the fluid coating.

18. A liquid film coating process in accordance with claim 17, wherein the organic liquid has a surface tension of at most 35 mN/m.

19. A liquid film coating process in accordance with claim 17, wherein the organic liquid is free from wetting agent.

20. A liquid film coating process in accordance with claim 17, wherein the organic liquid is removed from the fluid coating formed from the mixture on the object by evaporation in order to solidify the fluid coating or a liquid that can be polymerized by heating is used as the organic liquid in order to solidify the fluid coating formed on the object by polymerizing the organic liquid.
